(19) United States
(12) Patent Application Publication
(10) Pub. No.: US 2014/0004339 A1
(43) Pub. Date: Jan. 2, 2014

(54) POLYETHYLENE POWDERS AND POROUS ARTICLES MADE THEREFROM

(71) Applicants: Jens Ehlers, Hamminkeln (DE); Kerstin Lüdtke, Markkleeberg (DE); Julia Hufen, Rheinberg (DE); Ramesh Srinivasan, Cincinnati, OH (US); Björn Rinker, Hunxe (DE)

(72) Inventors: Jens Ehlers, Hamminkeln (DE); Kerstin Lüdtke, Markkleeberg (DE); Julia Hufen, Rheinberg (DE); Ramesh Srinivasan, Cincinnati, OH (US); Björn Rinker, Hunxe (DE)

(21) Appl. No.: 14/005,865

(22) PCT Filed: Apr. 6, 2012
(86) PCT No.: PCT/US12/32515

§ 371 Date: Sep. 18, 2013

Related U.S. Application Data
(60) Provisional application No. 61/473,286, filed on Apr. 8, 2011.

(51) Int. Cl. C08F 110/02

(52) U.S. Cl. CPC C08F 110/02
USPC 428/338; 428/402; 526/352; 521/143

(57) ABSTRACT

A polyethylene powder is described having a molecular weight in the range of from 3,000,000 g/mol to less than 4,000,000 g/mol as determined by ASTM 4020 and a bulk density of 0.10 to 0.20 g/cm³. On sintering, the polyethylene powder produces a porous article having an elastic modulus of at least 90 MPa.

### FIELD

The present invention relates to polyethylene powders and to porous articles made therefrom.

### BACKGROUND

Ultra-high-molecular weight polyethylene (UHMW-PE), high-density polyethylene (HDPE) and low-density polyethylene (LDPE) have all been used to produce porous molded articles. Examples of such articles include filter funnels, immersion filters, filter crucibles, porous sheets, pen tips, marker nibs, aerators, diffusers and light weight molded parts.

LDPE and HDPE, which include polyethylenes of molecular weight up to 250,000 g/mol, yield good part strength but their melt behavior results in a narrow processing window with respect to both time and temperature. As result, molded articles produced therefrom tend to be of reduced porosity and inconsistent quality. Furthermore, with LDPE or HDPE as the molding material, non-uniformity of heating within molds having complex geometric conduits tends to result in non-uniformity in the porosity of the molded article.

In contrast to LDPE and HDPE, UHMW-PE formulations (a designation generally assigned to ethylene polymers having an average molecular weight above 2,500,000 g/mol) can be processed over a wide range of time and temperature. Moreover, these high molecular weight polyethylenes are valued for properties such as chemical resistance, impact resistance, abrasion resistance, water absorption, energy absorption, heat deflection, and sound-dampening capabilities. However, since UHMW-PE seldom exhibits flowability even in the molten state, processing by conventional techniques, such as injection molding, is impossible and generally employs the powdered polymer rather than the molded pellets commonly used with lower molecular weight polymers. As a result, the properties of the polymer powder are critical to the properties of the final molded porous article.

In addition to molecular weight, one important property of an UHMW-PE powder is its bulk density, with lower bulk density values resulting in porous products of lighter weight and higher porosity. However, it is generally accepted in the art that low bulk density UHMW-PE powders result in porous articles that are weak and brittle. To address this problem, U.S. Pat. No. 4,925,880 teaches the addition of about 5 to about 60% by weight of the polyethylene wax to UHMW-PE powder having a molecular weight of 1,000,000 to about 6,000,000 g/mol and a bulk density within the range of about 350 to 500 grams per liter. However, the use of polyethylene wax in this manner restricts the time and temperature processing window of the UHMW-PE powder and necessarily results in loss in porosity of the sintered product.

In addition, International Publication No. WO 85/04365 discloses a sintering process whereby high molecular weight polyethylene powder is pre-compacted under pressure and heat to increase its bulk density. The compacted powders are reported to have bulk densities that are greater than 0.4 g/cc. The bulk density is increased by altering the particles' morphologies (removing the “fine structure”) by passing the powder through a pellet or roll mill. Again, however, the compaction is necessarily accompanied by loss in porosity of the sintered product.

U.S, Patent Application Publication No. 2007/0225390 discloses a molding powder comprising a polyethylene polymer, wherein the polyethylene polymer has a molecular weight in the range of from about 600,000 g/mol to about 2,700,000 g/mol as determined by ASTM 4020, an average particle size in the range of from about 5 microns to about 1000 microns, and a powder bulk density in the range of from about 0.10 to about 0.30 g/cc. On sintering the powder is said to produce a molded article with an average porosity between about 30% and about 85% and a flexural strength of at least 0.7 MPa.

International Patent Publication No. WO 2009/127410 discloses a process for producing UHMW-PE powder having a molecular weight of 1,000,000 to about 10,000,000 g/mol, a bulk density within the range of about 100 to 350 grams per liter and irregular particles having an average size (D₅₀) between 50 and 250 μm and a span (D₉₀-D₁₀/D₅₀) greater than 1 in the presence of a catalyst system comprising (I) the solid reaction product obtained from the reaction of: a) a hydrocarbon solution containing 1) an organic oxygen containing magnesium compound or a halogen containing magnesium compound and 2) an organic oxygen containing titanium compound and b) an organo aluminium halogen compound having the formula AlRₙX₃₋ₙ in which R is a hydrocarbon radical containing 1-10 carbon atoms, X is halogen and 0<3<n and (II) an aluminium compound having the formula AIR₃ in which R is a hydrocarbon radical containing 1-10 carbon atom.

According to the present invention, an UHMW-PE powder having a narrow range of molecular weight and low bulk density has been discovered that, on sintering, produces an article that is not only highly porous but also exhibits surprisingly high flexibility. As a result the powder can be sintered into thin porous sheets that can be bent into tubes without the breaking experienced with similar molecular weight materials of higher bulk density.

### SUMMARY

In one aspect, the invention resides in a polyethylene powder having a molecular weight in the range of from about 3,000,000 g/mol to less than 4,000,000 g/mol as determined by ASTM 4020 and having a bulk density of about 0.10 to about 0.20 g/cm³.

Conveniently, the polyethylene powder has a molecular weight in the range of from about 3,100,000 g/mol to about 3,700,000 g/mol as determined by ASTM 4020.

Conveniently, the polyethylene powder has a bulk density of about 0.15 to about 0.20 g/cm³.

Conveniently, the polyethylene powder has an average particle size (D₅₀) between about 60 and about 200 μm.

In another aspect, the invention resides in a porous article produced by sintering a polyethylene powder having a molecular weight in the range of from about 3,000,000 g/mol to less than 4,000,000 g/mol as determined by ASTM 4020 and having a bulk density of about 0.10 to about 0.20 g/cm³, the porous article having a porosity greater than 70%, such as greater than 75%, and an elastic modulus of at least 90 MPa, such as at least 100 MPa.

Conveniently, the porous article has a pressure drop of less than 10 mbar.

Conveniently, the porous article has an average pore size of about 50 to about 75 μm.

### BRIEF DESCRIPTION OF THE DRAWINGS

FIG. 1 is a graph of flexural strength and elastic modulus against bulk density for the polyethylene powder of Example 1 and the commercially available polyethylene powders listed in Table 1.

FIG. 2 is a graph of flexural strength and elastic modulus against viscosity number for the polyethylene powder of Example 1 and the commercially available polyethylene powders listed in Table 1.

### DETAILED DESCRIPTION

Described herein is an ultra-high molecular weight polyethylene (UHMW-PE) powder having a low bulk density, its production by Ziegler-Natta catalysis and its use to produce porous sintered articles having a high modulus of elasticity, high degree of porosity and a low pressure drop.

Polyethylene Powder

The present polyethylene powder has an average molecular weight in the range of from about 3,000,000 g/mol to less than 4,000,000 g/mol, and generally in the range of in the range of from about 3,100,000 g/mol to about 3,700,000 g/mol, as determined by ASTM-D 4020. The powder may have a monomodal molecular weight distribution or a bimodal molecular weight distribution, in the latter case with a first fraction of the powder having a molecular weight in the range of about 200,000 g/mol to about 3,000,000 g/mol and a second fraction having a molecular weight in the range of about 1,000,000 g/mol to about 10,000,000 g/mol. Generally, the amount of the first molecular weight fraction is in the range of 0 to 50%.

In addition, the present polyethylene powder has a bulk density of between about 0.10 and about 0.20 g/cm³, and typically of about 0.15 to about 0.20 g/cm³. Polyethylene powder bulk density measurements referred to herein are obtained by DIN 53466.

Generally, the present polyethylene powder has an average particle size, D₅₀, between about 60 and about 200 μm, typically between about 100 and about 180 μm. In this respect, the polyethylene powder particle size measurements referred to herein are obtained by a laser diffraction method according to ISO 13320.

Another important property of the present polyethylene powder is its dry flow properties, that is the ability of the dry powder to flow through a confined space. This property is important since it determines how quickly the powder can be molded into a desired shape. In particular, the dry polyethylene powder is generally able to flow through a 25 mm nozzle in a period of no more than 15 seconds. Such a test is performed according to DIN EN ISO 6186.

Production of the Polyethylene Powder

The polyethylene powder employed herein is typically produced by the catalytic polymerization of ethylene, optionally with one or more other alpha-olefin comonomers, using a heterogeneous catalyst and an alkyl aluminum compound as a cocatalyst. Preferred heterogeneous catalysts include Ziegler-Natta type catalysts, which are typically halides of transition metals from Groups IV-VIII of the Periodic Table reacted with alkyl derivatives of metals or hydrides from Groups I-III. Exemplary Ziegler catalysts include those based on the reaction products of aluminum and magnesium alkyls and titanium tetra halides

The heterogeneous catalyst may be unsupported or supported on silica, magnesium chloride and other porous fine grained materials. The mechanical integrity of the catalyst particles may be improved by any known prepolymerization treatment.

The co-catalyst employed in the polymerization process is generally triisobutylaluminum, triethylaluminum, isoprenylaluminium, aluminoxanes and halide-containing species and mixtures thereof. Preferred alkyl aluminum compounds include triethylaluminum, triisobutylaluminum and isoprenylaluminium. The co-catalyst can be combined with the catalyst prior to introduction of the catalyst into the polymerization reactor or can be added directly to the reactor. In the former case, the co-catalyst is conveniently combined with the catalyst by suspending the solid catalyst in an organic solvent and then contacting the catalyst with the alkyl aluminum compound. Generally, where the main catalyst component is a titanium-containing compound, the amount of alkyl aluminum cocatalyst added to the slurry of catalyst in the organic solvent results in atomic ratio of Al:Ti in the cocatalyst/catalyst combination in the range of about 0.1:1 to about 800:1, especially in the range of about 1:1 to about 200:1. The preferred alkyl aluminium is triisobutlyaluminum and is added to provide an Al:Ti ratio of about 1:1 to about 50:1.

Alternatively, where the alkyl aluminum cocatalyst is added directly to the polymerization reactor, it is added in an amount to provide an Al:Ti ratio in the reactor in the range of about 0.001:1 to about 200:1, preferably about 0.01:1 to about 50:1.

The polymerization reaction may be carried out at a temperature in the range of between about 0° C. and about 130° C., more typically in the range of between about 20° C. and about 100° C., especially in the range of between about 40° C. and about 90° C. and an ethylene pressure in the range of between about 0.05 and about 50 MPa, such as between about 0.05 and about 10 Mpa, typically between about 0.05 and about 2 MPa.

The polymerization may be conducted in the gaseous phase in the absence of a solvent or, more preferably, is performed in the slurry phase in the presence of an organic diluent. Suitable diluents include butane, pentane, hexane, cyclohexane, nonane, decane, or higher homologues and mixtures thereof. The polymerization may be carried out batchwise or in continuous mode in one or multiple steps. The molecular weight of the polymer may be controlled by feeding hydrogen to the polymerization reactor. Generally the amount of hydrogen added is such that the ratio of hydrogen to ethylene in the reactor feed is in the range of about 0.01 to about 100 volume % hydrogen/MPa ethylene, and preferably the range of about 0.01 to about 10 volume % hydrogen/MPa ethylene for the single step reaction.

The average polymer particle size is controlled through the polymer yield per catalyst feed. The bulk density may be controlled through the kind of pretreatment of the catalyst with aluminum alkyl, the ratio of cocatalyst versus catalyst, the polymerization pressure and the residence time in the polymerization reactor.

The average polymerization time is in the range of about 1 to about 12 hour, generally about 2 to about 9 hours. The overall catalyst consumption in the polymerization is in range of about 0.01 to about 5, typically about 0.02 to about 1.5 mmol of Ti per kilogram of polymer.

The polymerization may be carried out in a single step or in multiple steps. For example, to produce a polymer with a bimodal molecular weight distribution, it is preferred to produce the higher molecular weight fraction in a first step, optionally followed by a second step to produce the lower molecular weight fraction within individual higher molecular weight polymer particles.

When polymerization is complete, the ethylene polymer is isolated and dried in a fluidized bed drier under nitrogen. High boiling point solvent may be removed by steam distillation. Salts of long chain fatty acids may be added to the polymer powder as a stabilizer. Typical examples are calcium, magnesium and zinc stearate. Additional materials may be added to the polymer powder, depending on the desired properties of the porous sintered article. For example, it may be desirable to combine the polyethylene powder with activated carbon for filtering applications. The powder may also contain additives such as lubricants, dyes, pigments, antioxidants, fillers, processing aids, light stabilizers, neutralizers, antiblock, and the like. Preferably, the molding powder consists essentially of polyethylene polymer, such that additional materials do not alter the basic and novel characteristics of the powder, namely its processing flexibility and its suitability for forming articles with a high modulus of elasticity, a high degree of porosity and a low pressure drop.

Production of Porous Articles

Porous articles may be formed by a free sintering process which involves introducing the polyethylene polymer powder described above into either a partially or totally confined space, e.g., a mold, and subjecting the molding powder to heat sufficient to cause the polyethylene particles to soften, expand and contact one another. Suitable processes include compression molding and casting. The mold can be made of steel, aluminum or other metals. The polyethylene polymer powder used in the molding process is generally ex-reactor grade, by which is meant the powder does not undergo sieving or grinding before being introduced into the mold. The additives discussed above may of course be mixed with the powder.

The mold is heated in a convection oven, hydraulic press or infrared heater to a sintering temperature between about 140° C. and about 300° C., such as between about 160° C. and about 300° C., for example between about 170° C. and about 240° C. to sinter the polymer particles. The heating time and temperature vary and depend upon the mass of the mold and the geometry of the molded article. However, the heating time typically lies within the range of about 25 to about 100 minutes. During sintering, the surface of individual polymer particles fuse at their contact points forming a porous structure. Subsequently, the mold is cooled and the porous article removed. In general, a molding pressure is not required. However, in cases requiring porosity adjustment, a proportional low pressure can be applied to the powder.

The resultant porous sintered article has a porosity greater than 70%, such as greater than 75%, and an elastic modulus of at least 90 MPa, such as at least 100 MPa. In this respect, the porosity values cited herein are determined by mercury intrusion porosimetry according to DIN 66133, whereas elastic modulus values are determined according to EN ISO 178.

Generally, the porous sintered article has a pressure drop less of than 10 mbar, such as 8 mbar or less. Pressure drop values are measured using a sample of the porous article having a diameter of 140 mm, a width of 6.2-6.5 mm (depending on shrinkage) and an airflow rate of 7.5 m ³/hour and measuring the drop in pressure across the width of the sample.

Generally, the sintered article has an average pore size of at least 50 μm, typically about 50 to 75 μm, as determined according to DIN ISO 4003.

Uses of Porous Articles

The properties of the porous sintered articles produced from the present polyethylene powder make them useful in a wide variety of applications. In particular, because of their high flexibility, it is possible to produce thin porous sheets that can be bent into tubes for use as water and air filters.

The invention will now be more particularly described with reference to the following non-limiting Examples and the accompanying drawings.

In the Examples, viscosity numbers (VN), which are proportional to molecular weight of the powders tested, are determined according to DIN EN ISO 1628. Dry powder flow is measured using a 25 mm nozzle according to DIN EN ISO 6186.

### POLYMERIZATION EXAMPLE 1

Ethylene polymerization was performed in a single step continuous process using a mixture of saturated hydrocarbons having a boiling point range of 140° C.-170° C. (Exxsol D30) as the suspension medium. Prior to use, the suspension medium had been purified to remove catalyst poisons. The polymerization was carried out in a 40 liter reactor at a reaction temperature of 65 to 75° C., and an ethylene partial pressure in the range of 0,2 MPa to 0,4 MPa.

The polymer powder is separated from the solvent by steam distillation. The resulting powder is then dried in a fluidized bed under nitrogen and found to exhibit the properties listed in Table 1. The properties of a number of commercially available UHMW-PE powders are also listed in Table 1.

TABLE 1

| | Ex- | GUR | GUR | GUR | GUR | GUR |
|---|---|---|---|---|---|---|
| Powder | ample 1 | 2122 | 2122-5 | 2122y | 4122-5 | 4113 |
| VN, ml/g | 1750 | 2050 | 2050 | 1950 | 2200 | 2000 |
| MW, 10⁶ | 3.3 | 4.1 | 4.1 | 3.8 | 4.5 | 3.9 |
| g/ml | | | | | | |
| Bulk density, | 0.17 | 0.23 | 0.23 | 0.23 | 0.41 | 0.45 |
| g/ml | | | | | | |
| d50, μm | 145 | 140 | 200 | 70 | 170 | 120 |
| Dry powder | 12 | 9 | 5 | Not | 5 | 5 |
| flow, secs | | | | measured | | |

### FORMULATION EXAMPLE 2

Porous products are prepared from the unblended polyethylene powder of Polymerization Example 1 and the other materials listed in Table 1. In each case the porous products are produced by a free sintering process in the polyethylene polymer powder is introduced into a mold and then subjected to heat sufficient to cause the polyethylene particles to soften, expand and contact one another. The mold is heated in a convection oven to a sintering temperature of 220° C. to sinter the polymer particles. The heating time is 30 minutes. The physical properties of the resultant products are tested and the results are shown in Table 2.

TABLE 2

| Product | Example 2 | 2122 | 2122-5 | 2122y | 4122-5 | 4113 |
|---|---|---|---|---|---|---|
| Strength, MPa | 0.4 | 0.8 | 0.6 | 1.23 | 2 | 2.1 |
| Elastic modulus, | 115 | 25 | 18 | 38 | 70 | 84 |
| MPa | | | | | | |
| Pore size, μm | 64 | 50 | 55 | 35 | 37 | 33 |
| Porosity, % | 80 | 70 | 70 | 65 | 50 | 45 |
| Pressure drop, | 3 | 8 | 4 | 18 | 17 | 24 |
| mbar | | | | | | |

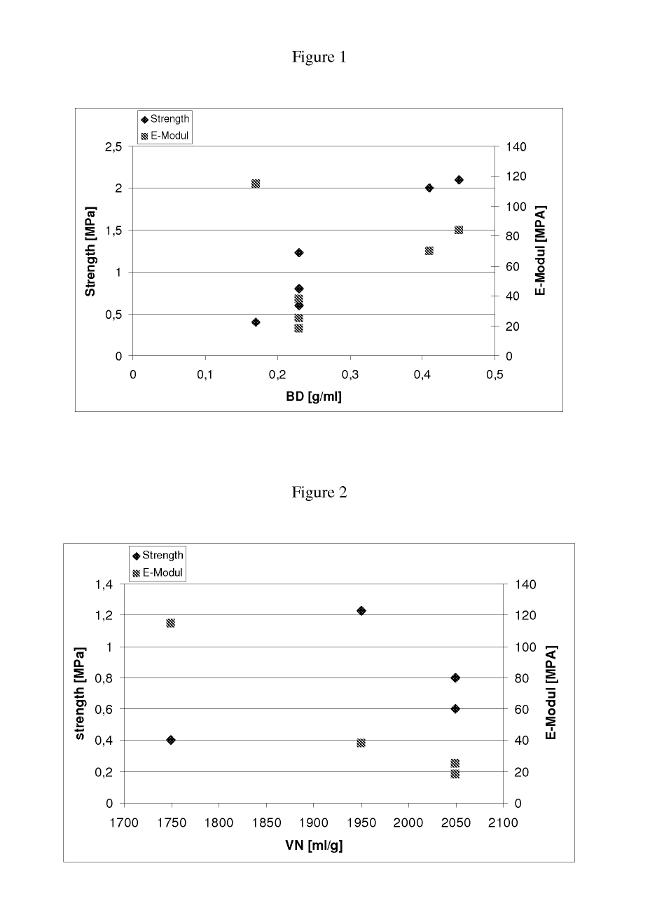

The results shown in Tables 1 and 2 are also plotted in FIGS. 1 and 2, which show that the powder of Example 1 produces a porous sintered product with an unexpectedly high elastic modulus.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A polyethylene powder having a molecular weight in the range of from 3,000,000 g/mol to less than 4,000,000 g/mol as determined by ASTM 4020 and a bulk density of 0.10 to 0.20 g/cm³.

2. The powder of claim 1, and having a molecular weight in the range of from 3,100,000 g/mol to 3,700,000 g/mol as determined by ASTM 4020.

3. The powder of claim 1 and having a bulk density of 0.15 to 0.20 g/cm³.

4. The powder of claim 1 and having an average particle size (D₅₀) between 60 and 200 μm.

5. A porous article produced by sintering a polyethylene powder having a molecular weight in the range of from about 3,000,000 g/mol to less than 4,000,000 g/mol as determined by ASTM 4020 and having a bulk density of about 0.10 to about 0.20 g/cm³, the porous article having a porosity greater than 70% and an elastic modulus of at least 90 MPa.

6. The porous article of claim 5 and having a porosity greater than 75%.

7. The porous article of claim 5 and having an elastic modulus of at least 100 MPa.

8. The porous article of claim 5 and having a pressure drop of less than 10 mbar.

9. The porous article of claim 5 and having an average pore size of 50 to 75 μm.

10. The porous article of claim 5, wherein said sintering is conducted at a temperature between 140° C. and 300° C. for a time of 25 to 100 minutes.

11. The porous article of claim 5, wherein the polyethylene polymer has a molecular weight in the range of from about 3,100,000 g/mol to about 3,700,000 g/mol as determined by ASTM 4020.

12. The porous article of claim 5, wherein the powder has a bulk density of about 0.15 to about 0.20 g/cm3.

13. The porous article of claim 5, wherein the powder has an average particle size (D50) between about 60 and about 200 μm.
